(19) United States
(12) Patent Application Publication
(10) Pub. No.: US 2003/0227563 A1
(43) Pub. Date: Dec. 11, 2003

(54) Video signal photography device

(76) Inventor: Jack Ting, Taipei (TW)

Correspondence Address: Leong C. Lei, PMB#1008, 1867 Ygnacio Valley Road, WALNUT CREEK, CA, 94598-3214, US

(21) Appl. No.: 10/164,393

(22) Filed: Jun. 10, 2002

(51) Int. Cl. H04N 5/225

(52) U.S. Cl. 348/375

(57) ABSTRACT

A video photography device having moveable polarizer is disclosed, and the device comprises a seat body, images signal transmission lines, a flexible bellow tube and a lens-photography box, the top face of the seat body being positioned to one end of the bellow tube and the other end of the bellow tube connected to the lens-photography box, and the transmission line passed through the seat body and the bellow tube to the inner wall of the box, and the photography signal circuit corresponding to connection point, characterized in that, the housing of the lens-photography box includes a fixed rear cover mounted to the lens front cover by means of a fixing shaft end, and the bottom section of the rear cover is connected to the bellow tube and within the lens front cover, photography signal circuit is provided and the wall at the other end of the of the fixed rear cover is connected to the front cover to form a lens, wherein the center of the lens is at the same position of the shaft center of the fixed shaft. The present photography device allows fine adjustment of shooting angle and can be collected in a circular disc for convenient transportation.

### BACKGROUND OF THE INVENTION

(a) Field of the Invention

The present invention relates to structure of a self-positioning structure, and in particular to a structure where the frame body can be conveniently positioned.

(b) Description of the Prior Art

Conventional digital video camera is normally provided with a digital photography module at one end of the disc seat and the range of the photography is limited and therefore, the position of shooting is very limited. Besides the lens of the camera cannot provide vertical shooting from a sloping region. Accordingly, it is an object of the present invention to provide a video photography device which mitigates the above drawbacks.

### SUMMARY OF THE INVENTION

Accordingly, it is an object of the present invention to provide a video photography device having moveable polarizer comprising a seat body, images signal transmission lines, a flexible bellow tube and a lens-photography box, the top face of the seat body being positioned to one end of the bellow tube and the other end of the bellow tube connected to the lens-photography box, and the transmission line passed through the seat body and the bellow tube to the inner wall of the box, and the photography signal circuit corresponding to connection point, characterized in that, the housing of the lens-photography box includes a fixed rear cover mounted to the lens front cover by means of a fixing shaft end, and the bottom section of the rear cover is connected to the bellow tube and within the lens front cover, photography signal circuit is provided and the wall at the other end of the of the fixed rear cover is connected to the front cover to form a lens, wherein the center of the lens is at the same position of the shaft center of the fixed shaft.

Another object of the present invention is to provide a video photography device having moveable polarizer, wherein the seat body includes a seat top housing a seat bottom housing and a circular recess is formed between the two housings and the top housing is provided with a through hole for the passage of the transmission lines to the bellow tube to the inner wall of the lens-photography box to connect to the corresponding connection point of the signal circuit.

Other objects, advantages, and novel features of the invention will become more apparent from the following description when taken in conjunction with the accompanying drawings.

### BRIEF DESCRIPTION OF THE DRAWINGS

FIG. 1 is a perspective view of a video photography device having moveable polarizer in accordance with the present invention.

FIG. 2 is a side view of a video photography device having moveable polarizer in accordance with the present invention.

FIG. 3 is a top view of a video photography device having moveable polarizer in accordance with the present invention.

FIG. 4 is a perspective exploded view of a video photography device having moveable polarizer in accordance with the present invention.

FIG. 5 is a schematic view showing the operation of the video photography device having moveable polarizer in accordance with the present invention.

FIG. 6 is a schematic view showing the collection of the photography device within the circular disc of the video photography device in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

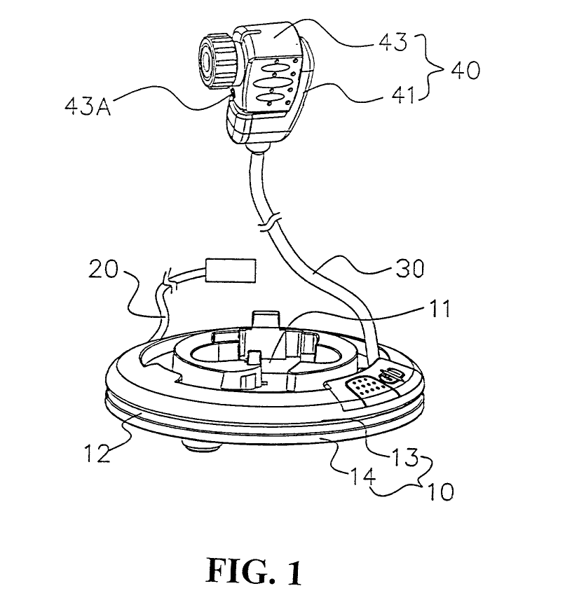

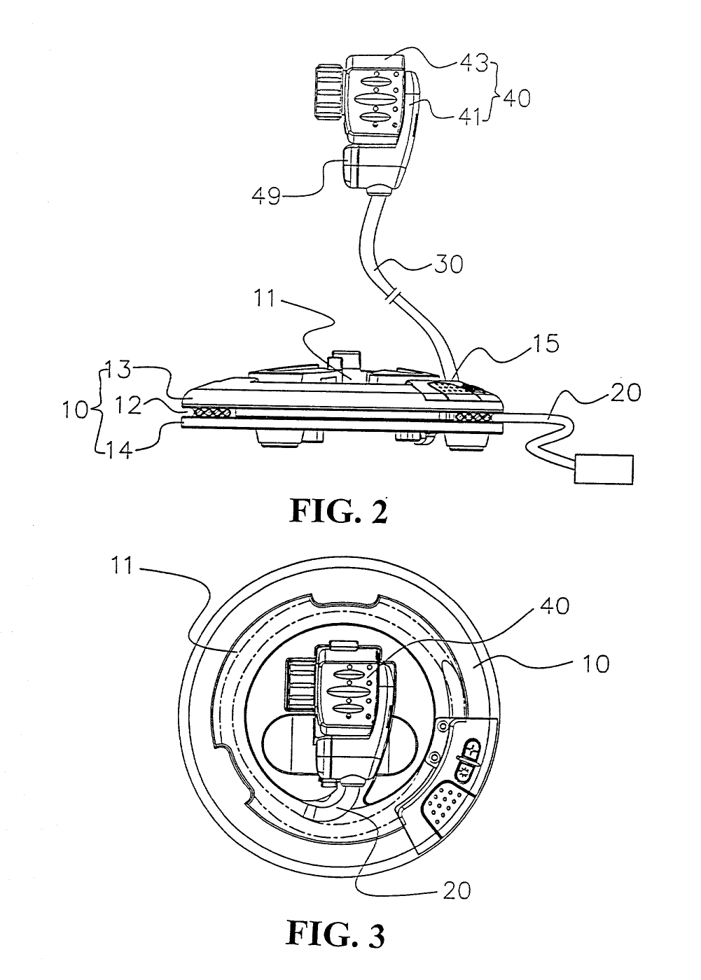

Referring to FIGS. 1, 2, and 3, there is shown a video photography device having moveable polarizer in accordance with the present invention. The photography device 1 comprises a seat body 10, images signal transmission lines 20, a flexible bellow tube 30 and a lens-photography box 40. The top face of the seat body 10 is positioned to one end of the bellow tube 30 and the other end of the bellow tube 30 is connected to the lens-photography box 40, and the transmission line 20 passes through the seat body 10 and the bellow tube 30 to the inner wall of the box 40. The photography signal circuit (not shown) is corresponding to the connection point, and top face of the seat body 10 is provided with collection recess 11 of the box 40 and the bellow tube 30 such that the box 40 and the bellow tube 30 are collected to the collection recess 11, as shown in FIG. 3, and the middle section of the side edge of the seat body 10 is provided with line collection recess 12 for collecting of transmission lines 20.

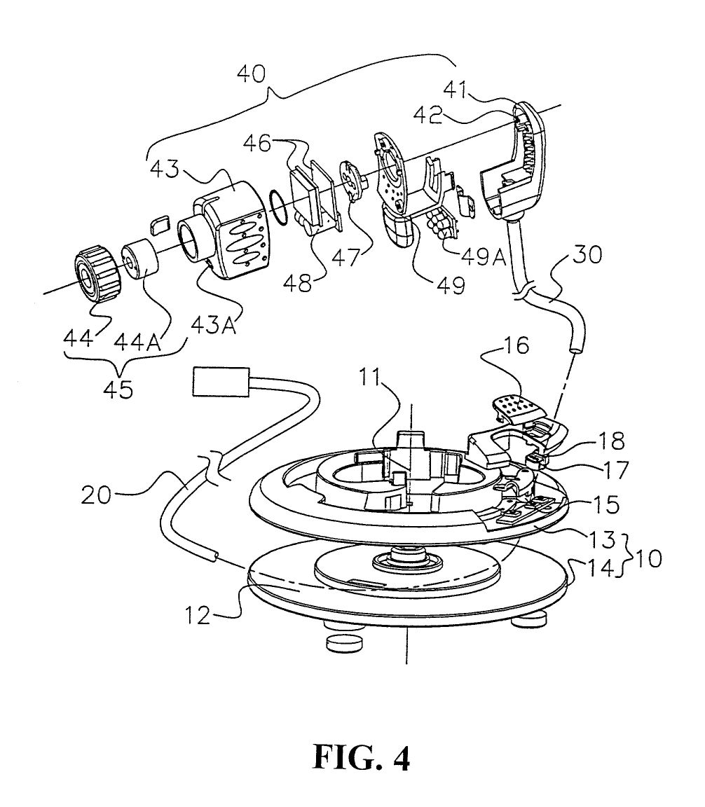

As shown in FIG. 4, the seat body 10 includes a seat top housing 13, a seat bottom housing 14 mounted to each other form top to bottom, and a circular recess 12 is formed between the two housings 13, 14 and the top housing 13 is provided with a through hole 15 for the passage of the transmission lines 20 to the bellow tube 30 to the inner wall of the lens-photography box 40 to connect to the corresponding connection point of the signal circuit 46. The top face of the seat top housing 13 is connected to the image transmission line 20 at an appropriate position and is provided with initial switch 16 and a plurality of control switch 17, 18 to proceed with photography operation and control. Further, the housing of the photography box 40 is provided with a fixed rear cover 41 mounted with a fixing shaft 42, and the end of the shaft 42 is a lens front cover 43, and the bellow tube 30 at the bottom section of the fixed rear cover 41, at the appropriate position of the lens front cover 43, photography signal circuit 46, a fixing block 47, a laser module 48 and a cover plate 49 for mounting the front end of the rear cover 41 are provided, and the front cover 43 corresponding to the front end of the laser module 48, is provided with a projection hole 43A, and the wall at the other end of the fixed rear cover 41 connected to the lens front cover 43 is formed into ring shape, covering the focusing adjusting ring 44 of the lens 45, and a LED module 49A is provided between the cover plate 49 and the fixed covering plate 41, and the cover plate 49 corresponding to the plate face of the LED module 49A is formed into transparent or semi-transparent plate and the Laser module and LED module 49A are directly obtained power from the lens-photography box via the transmission line 20.

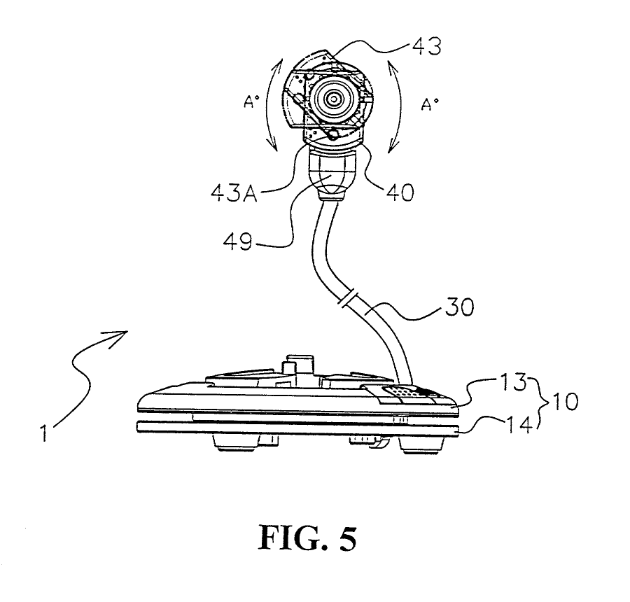

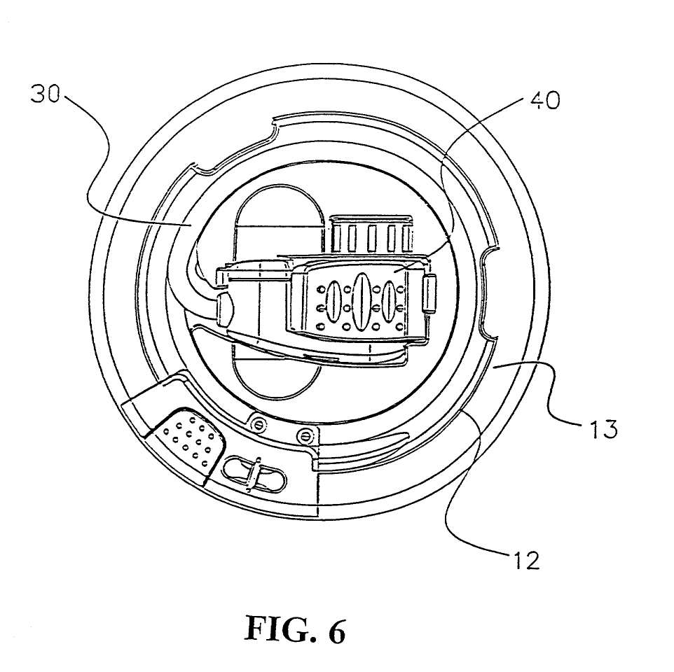

When in use, as shown in FIG. 5, the bellow tube 30 can be adjusted and the rear cover 43 of the lens-photography box 40 is position at a vertical such that photography shooting can be done within the scope of angle A degree and the sloping angle for shooting can be finely adjusted. When not in use, the device can be rolled and collected and the device in accordance with the present invention can be conveniently brought along.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A video photography device having moveable polarizer comprising a seat body, images signal transmission lines, a flexible bellow tube and a lens-photography box, the top face of the seat body being positioned to one end of the bellow tube and the other end of the bellow tube connected to the lens-photography box, and the transmission line passed through the seat body and the bellow tube to the inner wall of the box, and the photography signal circuit corresponding to connection point, characterized in that, the housing of the lens-photography box includes a fixed rear cover mounted to the lens front cover by means of a fixing shaft end, and the bottom section of the rear cover is connected to the bellow tube and within the lens front cover, photography signal circuit is provided and the wall at the other end of the of the fixed rear cover is connected to the front cover to form a lens, wherein the center of the lens is at the same position of the shaft center of the fixed shaft.

2. The video photography device having moveable polarizer of claim 1, wherein the seat body includes a seat top housing a seat bottom housing and a circular recess is formed between the two housings and the top housing is provided with a through hole for the passage of the transmission lines to the bellow tube to the inner wall of the lens-photography box to connect to the corresponding connection point of the signal circuit.

3. The video photography device having moveable polarizer of claim 1, wherein the top face of the seat body is provided with the bellow tube and a collection recess of the lens-photography box.

4. The video photography device having moveable polarizer of claim 1, wherein the middle section of the seat body side edge is provided with a recess for the collection of the image transmission line.

5. The video photography device having moveable polarizer of claim 1, wherein the top face of the seat body is connected to the image transmission line at an appropriate position and is provided with initial switch and a plurality of control switch.

6. The video photography device having moveable polarizer of claim 1, wherein within the lens-front cover, photography signal circuit, a fixing block a laser module and a cover plate for mounting the front end of the rear cover are provided, and the front cover corresponding to the front end of the laser module, is provided with a projection hole, and the wall at the other end of the fixed rear cover connected to the lens front cover is formed into ring shape, covering the focusing adjusting ring of the lens, and a LED module is provided between the cover plate and the fixed covering plate, and the cover plate corresponding to the plate face of the LED is formed into transparent or semi-transparent plate and the Laser module and LED module are directly obtained power from the lens-photography box via the transmission line.
